(19) United States
(12) Patent Application Publication
(10) Pub. No.: US 2022/0178102 A1
(43) Pub. Date: Jun. 9, 2022

(54) RECYCLED PLASTIC PRODUCTS AND METHODS

(71) Applicant: TAP Industries LLC, Malone, NY (US)

(72) Inventors: Tim J. CARTER, Malone, NY (US); Travis PRITCHARD, Malone, NY (US)

(73) Assignee: TAP Industries LLC, Malone, NY (US)

(21) Appl. No.: 17/113,805

(22) Filed: Dec. 7, 2020

(51) Int. Cl. E02D 17/20; B29B 9/06; B29B 17/02; B29B 17/04; B29C 39/00

(52) U.S. Cl. CPC E02D 17/205; B29B 9/06; B29K 2509/08; B29B 17/0412; B29C 39/003; B29B 17/02

(57) ABSTRACT

A method of making a recycled plastic product includes collecting recyclable plastic materials. The recyclable plastic materials are separated into a plurality of single grade batches of recyclable plastic materials. Each single grade batch is ground into a single grade group of recyclable plastic chips. A single grade portion is weighed out from each single grade group of chips. Each single grade portion is equal in weight within a range of plus or minus 15 percent. Each single grade portion is mixed together to form a multiple grade mixture of recyclable plastic chips. The multiple grade mixture is heated to form a multiple grade blend of molten recyclable plastic. The multiple grade blend is cooled into a form of a solid recycled plastic product. The recycled plastic product comprises multiple grades of recyclable plastic and a volume large enough to encompass a 1.0-inch diameter sphere.

### TECHNICAL FIELD

The present disclosure relates to recycled plastic products and methods of making the same. More specifically, the disclosure relates to methods of making recycled plastic products from multiple grades of recyclable plastics.

### BACKGROUND

Only a small percentage of recyclable plastic materials are actually recycled. Up to about 80 percent or more of recyclable plastic materials end up in a landfill or in the ocean, because it is too costly and/or too difficult for a Material Recycling Facility (MRF) to process into a commercially viable recycled plastic product. Some of the main reasons for this are as follows:
The recyclable plastic materials are often coated with a significant (e.g., above 1 percent or more by volume) amount of contaminates that are difficult to remove and may cause unusable defects in the recycled plastic product.
The recycled plastic product must be composed of substantially (e.g., 95 percent or more by weight) a single grade type of recyclable plastic because the various grades of plastic do not bind readily and may cause fractures in the final recycled plastic product.

For example, plastic bunker wrap is a thick plastic film that is used to cover large quantities of agricultural products, such as corn, wheat, straw or grain. However, the entire bottom side of the bunker wrap that touches the agricultural product becomes covered with agricultural residue (contaminates) that adheres to the bottom surface of the bunker wrap when it is peeled away. A problem with washing plastic film, such as bunker wrap, is that the film will often overlap on itself and close on the contaminates, therefore holding the contaminates in place and preventing them from being washed away. Accordingly, MRFs will most often not take bunker wrap or other plastic film products, such as plastic bags, because the contaminates are too costly to remove.

Contaminates that coat recyclable plastic material are especially problematic when the contaminated recycled plastic material is used to make recycled plastic products that have a minimum dimension of less than 1 inch. Examples of such thin recycled plastic products are: recycled plastic bottles, tee shirts, flooring or plastic films. In those cases, even a small amount of contaminates may cause fractures in the product that are proportionally unacceptable in size compared to the smallest dimensions of the product.

Additionally, different grades of recyclable plastics do not bind together easily. Therefore, most recycled plastic products must be made of a single grade of plastic. For example, recycled plastic bottles are often made of only grade 1 type plastic. If they were to be made of, for example, ninety percent grade 2 and ten percent grade 1 by weight, the different grades of plastic would be distributed unevenly throughout the bottles and may cause weak spots which could fracture and leak liquid.

Accordingly, there is a need for recycled plastic products and methods that can include contaminates without causing a significant amount of weaknesses and fractures in the products. Additionally, there is a need for recycled plastic products and methods that can include multiple grades of plastic that bind with significant enough strength to reduce fracturing, to enhance plastic recycling and, therefore, reduce dumping of recyclable plastic materials into landfills or oceans.

### BRIEF DESCRIPTION

The present disclosure offers advantages and alternatives over the prior art by providing recycled plastic products and methods of making recycled plastic products, wherein the recycled plastic products may be a composite of multiple grades types of recyclable plastic. Moreover, the recycled plastic products may be a composite of all grade types 1 through 6 of recyclable plastic. Each grade of recyclable plastic in the recycled plastic product may be of equal amount by weight within a range of plus or minus 15 percent.

Additionally, the recycled plastic products may include sand mixed throughout the entire product. The sand may have a weight within a range of 1 to 4 percent of a combined weight of the plurality of grades of recyclable plastic within the product. The sand may also having a grain size within a range of 0.25 to 2 millimeters. Further, the recycled plastic product may include contaminates, other than sand, mixed throughout the entire product, wherein the contaminates weigh within a range of 10 percent to 90 percent of the weight of the sand. The grain size of the sand provides a large enough surface area to enhance bonding between the different grades of plastic.

The methods and products enable greater flexibility in recycling plastics from, for example, industrial sites and landfills. Further, recycling of plastics from residential and/or commercial sites would also be made easier. Additionally, contaminates that adhere to the surface of the plastic do not have to be filtered or washed out of the recyclable plastic during processing, which may significantly reduce the cost of recycling.

A method of making a recycled plastic product in accordance with one or more aspects of the present disclosure includes collecting recyclable plastic materials. The recyclable plastic materials are separated into a plurality of single grade groups of recyclable plastic materials. Each single grade group of recyclable plastic materials is ground into a single grade group of recyclable plastic chips. A single grade portion of recycled plastic chips is weighed out from each single grade group of recyclable plastic chips. Each single grade portion is equal in weight within a range of plus or minus 15 percent. Each single grade portion is mixed together to form a multiple grade mixture of recyclable plastic chips. The multiple grade mixture is heated to form a multiple grade blend of molten recyclable plastic. The multiple grade blend is cooled into a form of a solid recycled plastic product. The recycled plastic product comprises a composite of multiple grades of recyclable plastic.

A recycled plastic product, in accordance with one or more aspects of the present disclosure includes a plurality of grades of recyclable plastic mixed together throughout the entire product. Each grade of recyclable plastic being of equal amount by weight within a range of plus or minus 15 percent. The product has an overall volume large enough to encompass a spherical volume of at least 1.0 inch in diameter.

### DRAWINGS

The disclosure will be more fully understood from the following detailed description taken in conjunction with the accompanying drawings, in which:

FIG. 1 depicts an example of a flow diagram of a method of making recycled plastic product according to aspects described herein;

FIG. 2 depicts an example of a schematic of a step of the method of FIG. 1, wherein recyclable plastic materials are collected at a Material Recycling Facility (MRF);

FIG. 3 depicts an example of a perspective view of a conveyor system performing another step in the method of FIG. 1, wherein the recyclable plastic materials are separated into a plurality of single group batches of recyclable plastic materials;

FIG. 4 depicts an example of a perspective view of a grinding machine performing additional steps in the method of FIG. 1, wherein the single grade batches are ground down to single grade groups of recyclable plastic chips and thereafter, the chips are weighed out to provide single grade portions of equal weight recyclable plastic chips;

FIG. 5 depicts an example of a perspective view of a mixing machine performing additional steps in the method of FIG. 1, wherein the single grade portions of equal weight are mixed together to form a multiple grade mixture of recyclable plastic chips and thereafter, sand is mixed into the multiple grade mixture;

FIG. 6 depicts an example of a perspective view of an extruder performing additional steps in the method of FIG. 1, wherein the multiple grade mixture of recyclable plastic chips and sand are heated to form a multiple grade blend of molten recyclable plastic and thereafter, the multiple grade blend is cooled into the form of recycled plastic blocks; and

FIG. 7 depicts an example of a perspective view of an extruder performing additional steps in the method of FIG. 1, wherein the multiple grade mixture of recyclable plastic chips and sand are heated to form a multiple grade blend of molten recyclable plastic and thereafter, the multiple grade blend is cooled into the form of recycled plastic pellets.

### DETAILED DESCRIPTION

Certain examples will now be described to provide an overall understanding of the principles of the structure, function, manufacture, and use of the methods, systems, and devices disclosed herein. One or more examples are illustrated in the accompanying drawings. Those skilled in the art will understand that the methods, systems, and devices specifically described herein and illustrated in the accompanying drawings are non-limiting examples and that the scope of the present disclosure is defined solely by the claims. The features illustrated or described in connection with one example may be combined with the features of other examples. Such modifications and variations are intended to be included within the scope of the present disclosure.

The terms “significantly”, “substantially”, “approximately”, “about”, “relatively,” or other such similar terms that may be used throughout this disclosure, including the claims, are used to describe and account for small fluctuations, such as due to variations in processing from a reference or parameter. Such small fluctuations include a zero fluctuation from the reference or parameter as well. For example, they can refer to less than or equal to ±10%, such as less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

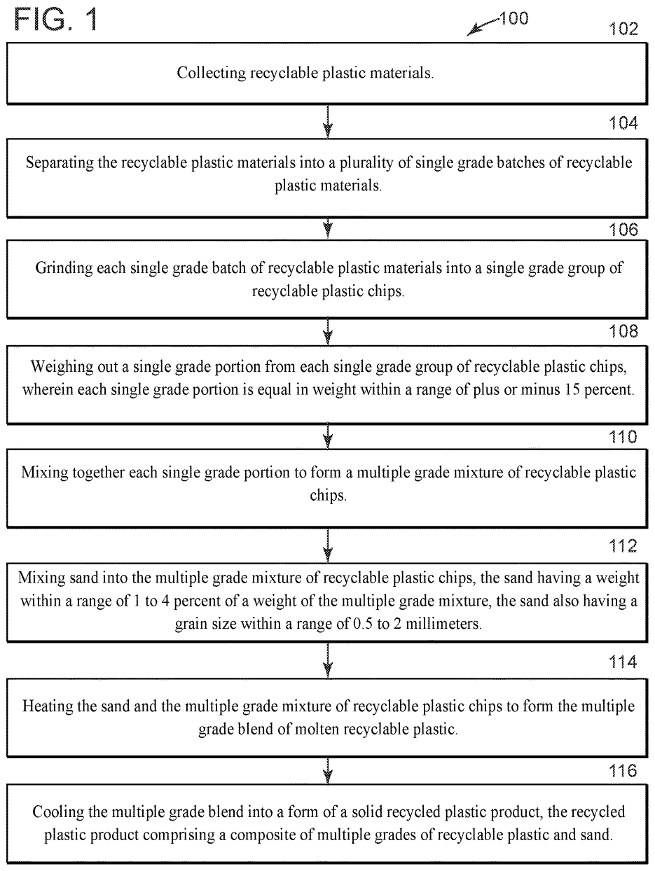

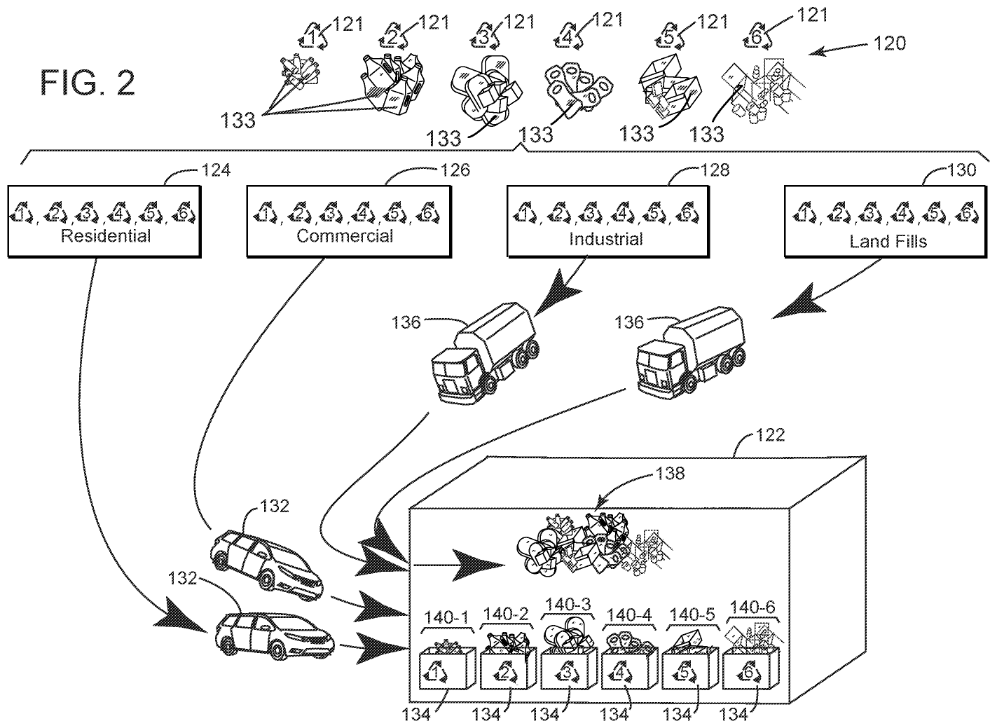

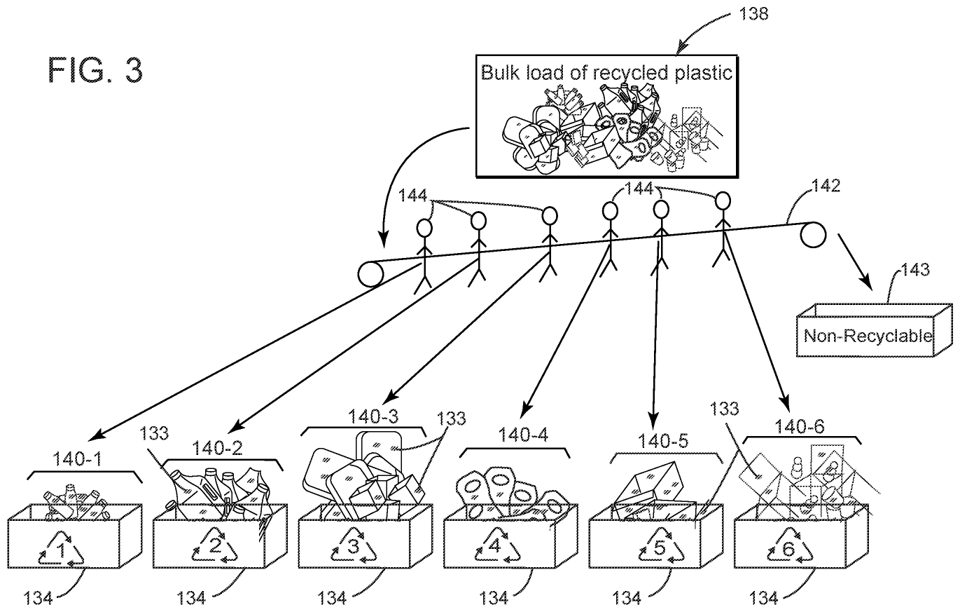

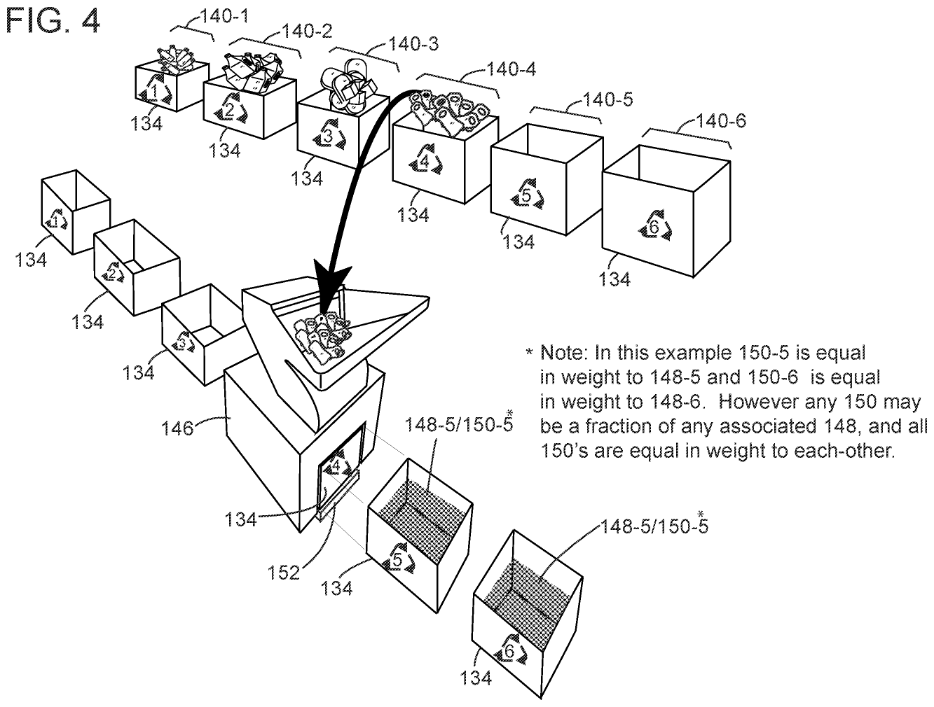

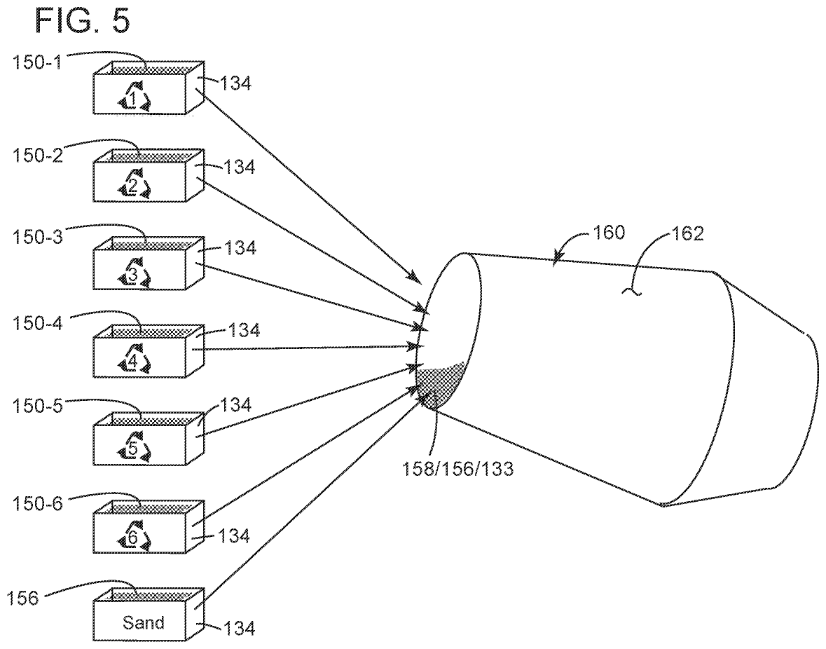

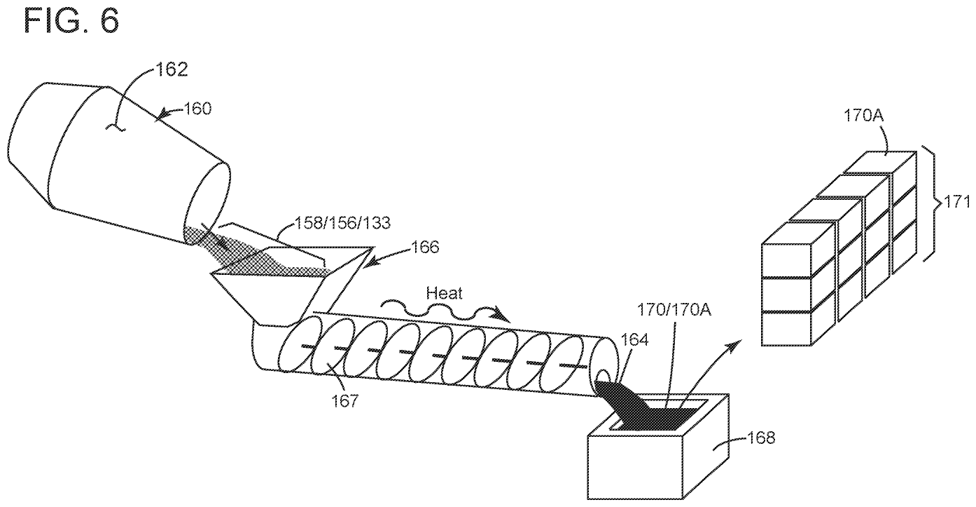

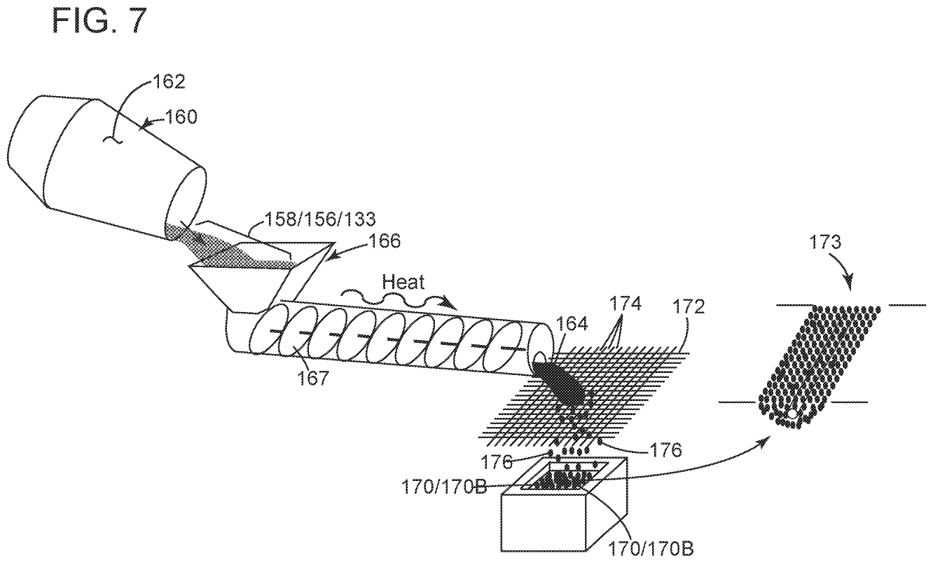

Referring to FIG. 1, an example of a flow diagram 100 of a method of making recycled plastic product is depicted according to aspects described herein. The method 100 includes steps 102-116, which will be discussed in detail with their associated FIGS. 2-7. More specifically, the method steps and their associated FIGS. are as follows:
Step 102: Associated with FIG. 2.
Step 104: Associated with FIG. 3.
Steps 106 and 108: Associated with FIG. 4.
Steps 110 and 112: Associated with FIG. 5.
Step 114 and 116, wherein the recycled plastic product is a block: Associated with FIG. 6.
Step 114 and 116 wherein the recycled plastic product is a plurality of pellets: Associated with FIG. 7

Referring to FIG. 2, an example is depicted of a schematic of step 102 of the method 100 of FIG. 1, wherein recyclable plastic materials 120 are collected at a Material Recycling Facility (MRF) 122. The recyclable plastic materials 120 are differentiated into six grade types depending on their chemical makeup.

The grade types are part of a classification system devised by the Plastics Industry Association (or “PLASTICS”), having headquarters in Washington, D.C., USA. The grades are displayed on the plastic packaging as a number within a recycle logo121, which is a triangle formed by arrows.

The following Table I summarizes the chemical composition and properties of the different grade types. Additionally, Table 1 provides examples of original products typically made by each grade, as well as examples of recycled products that are often made from those same grade type after they have been processed by a MRF 122.

TABLE 1
The 7 Grades of Plastic

| | | | Recycled |
|---|---|---|---|
| Grade | Properties | Examples | Products |
| 1 Polyethylene | Clarity, toughness, | Water bottles, food jars, | Fibers, tee shirts, |
| terephthalate | barrier to gas and | ovenable film, packaging. | drink bottles. |
| (PET or PETE) | moisture, heat | | |
| | resistant, sinks in | | |
| | water. | | |
| 2 High density | Toughness, resistance | Thin products e.g. milk | Plastic crates, |
| polyethylene | to moisture and | containers, juice bottles, | recycling bins, |
| (HDPE) | chemicals, ease of | butter tubs, cereal bags, | agricultural |
| | processing, | rubbish bags, wheelie | pipes, pallets. |
| | permeability to | bins, caps and closures. | |
| | gas, floats in water | | |
| 3 Polyvinyl | Clarity, ease of | Bottles for storing | Pipes, packaging. |
| chloride (PVC) | blending, strength, | cleaning products, | |
| | toughness, versatility, | plumbing pipes, medical | |
| | resistance to grease, | products, building | |
| | oil and chemicals, | windows. | |
| | sinks in water. | | |
| 4 Low density | Ease of processing, | Usually thin and pliable | Plastic bags, |
| polyethylene | strength, toughness, | e.g. shopping bags, | dispensing |
| (LDPE) | flexibility, ease of | squeeze bottles, | bottles, tubing. |
| | sealing, barrier to | disposable gloves, frozen | |
| | moisture, floats in | food containers, caps and | |
| | water. | closures. | |
| 5 Polypropylene | Strength, toughness, | Condiment bottles, | Rubbish bins, |
| (PP) | resistance to heat, | medicine bottles, straws, | auto parts, |
| | chemicals, grease | bottle caps, tupperware, | industrial fibers, |
| | and oil, versatility, | caps and closures, | pots, trays, tubs, |
| | barrier to moisture, | buckets. | crates, pallets. |
| | floats in water. | | |
| 6 Polystyrene | Versatility, insulation, | Disposable cups, cutlery, | Pots, tubs, trays. |
| (PS) | clarity, easily formed, | food boxes, packaging | |
| | sinks in water. | foam. | |
| 7 Miscellaneous | Comprises plastics | A large variety of plastics | Car parts, pallets, |
| | that are not defined | e.g. baby bottles, compact | storage racking. |
| | by the other 6 grades. | discs, storage containers, | |
| | Normally sinks in | number plates. | |
| | water. | | |

Grades (or grade types) 1-bare generally recycled at the MRF 122. Grade type 7, i.e., miscellaneous plastics that are not defined by the other six grades, are generally not recycled at the MRF 122.

Recyclable plastic materials 120 may be collected from residential facilities 124, commercial facilities 126, industrial manufacturing plants 128 and landfills 130. Two separate collection methods are often utilized depending on whether the recyclable plastics 120 are collected from residential and commercial facilities 124, 126 or from industrial plants and landfills 128, 130.

The recyclable plastic materials 120 are collected at the MRF 122 in full form. For example, the recyclable plastic materials 120 may be kid's toys, food containers, patio furniture, shipping containers, plastic bottles, plastic bags, plastic film bunker wrap for covering large quantities of agricultural products stored in silos, many other types of plastic films and other post consumer plastic products.

The surface of the recyclable plastic materials 120 may be covered with a significant amount of waste residue or contaminates 133. For example, because plastic bunker wrap is often used to cover agricultural products, an entire side of the bunker wrap may be covered in agricultural contaminates 133, such as straw, corn, wheat or the like. Plastic peanut butter jars may have their internal surface covered with an oily peanut butter residue, which is also a contaminate 133. Also, by way of example, plastic wrapping used to cover boats in storage, may have a significant amount of dirt contaminate 133 that was picked up when the plastic 120 was peeled from the boat and thrown on the ground.

Prior art methods of making recycled plastic products from the collected recyclable plastic material 120 often require that virtually all of the contaminates 133 be removed from the plastic material 120 during processing at the MRF 122. Problematically, this can be difficult and expensive to achieve.

For example, washing may not remove all contaminates 133 from the plastic 120. This is especially the case with plastic films, which have a tendency to fold over themselves to trap some of the contaminates 133 within the folds of the plastic film. This is often the reason why many MRFs do not accept film plastic, even though they are theoretically recyclable.

Also, by way of example, prior art methods of making recycled plastic products often filter contaminates 133 out of molten plastic 120 prior to forming the final products. However, the filters require fine screens to remove virtually all of the contaminates 133, which means that they get clogged often. Therefore, the clogged filters have to be removed and replaced frequently, often every few minutes. Because of the need to replace such screens frequently, filtering out contaminates may make the recycling process too expensive to be commercially feasible.

Advantageously however, as will be discussed in greater detail herein, method 100 of the present invention may not require that virtually all contaminates 133 be removed during processing. In other words. the recycled plastic product made from utilizing method 100 may include significant amounts of contaminates embedded therein.

Generally, collections of recyclable plastics 120 from residential 124 or commercial 126 facilities are performed by personnel 132 associated with the facilities, wherein the personnel 132 transport the plastics 120 to the MRF 122 in light duty vehicles. The personnel 132 then separate the recyclable plastics 120 by hand into single grade batches 140-1-140-6. Each batch 140 contains a single grade of the various grades 1-6 of plastics 120. Alternatively, the personnel 132 may drive the unsorted recyclable plastic 120 to a remote pick-up station (not shown), where the personnel 132 may then sort the plastics 120 into separate single grade batches 140.

For purposes herein, each single grade batch 140 will be given the base reference number 140, followed by a dash number 1-6 that is its associated grade. When referring to the single grade batches in general, the base reference number 140 will be used. When referring to the specific grades of batches, the base reference number along with its grade number will be used. For example, the specific grades of single grade batches will have the following reference numbers:

| Batch grade | Reference No. |
|---|---|
| grade 1 | 140-1 |
| grade 2 | 140-2 |
| grade 3 | 140-3 |
| grade 4 | 140-4 |
| grade 5 | 140-5 |
| grade 6 | 140-6 |

Moreover, this type of referencing scheme will be utilized herein for:
single grade groups of recyclable plastic chips 148-1 through 148-6; and
single grade portions of equal weight recyclable plastic chips 150-1 through 150-6.

Collection from industrial facilities 128 or landfills 130 are most often performed by a separate collection contractor 136, which is hired to haul unsorted bulk loads 138 of plastic materials 120 from the industrial plant 128 or landfill 130. The bulk loads 138 are delivered to the MRF 122 in heavy duty vehicles.

Referring to FIG. 3, an example is depicted of a perspective view of a conveyor belt system 142 performing step 104 of method 100 of FIG. 1. In this example, the conveyor belt system 142 facilitates the separation of the bulk load 138 of unsorted recyclable plastic materials 120 into a plurality of single grade batches 140-1 through 140-6 of recyclable plastic materials 120.

The bulk load 138 of recyclable plastic materials 120 may be placed on a slow-moving conveyor belt system 142 at the MRF 122. A plurality of staff 144 associated with the MRF 122 will then separate the various grades 1-6 of plastic 120 from the conveyor belt system 142 and a place them into individual bins 134, wherein each bin 134 holds one single grade batch 140 of the plurality of single grade batches 140-1 through 140-6.

The process of separating the grades 1-6 from the conveyor belt system 142 is often performed by teams of multiple staff members 144. Each team of staff members 144 may be tasked with removing only a single grade of plastic materials 120. So, for example, a first team of staff 144 may remove only grade 1 plastic 120, a second team of staff 144 may remove only grade 2 plastic 120 and so on. Therefore, by the time the plastic 120 reaches the final team of staff 144, only non-recyclable material 143 is left for return to the landfill.

Prior art methods of making recycled plastic products often require that the recyclable plastic materials 120 be separated into their various grade types 1-6 because each recycled plastic product will be made from a single grade type. For example, as shown earlier in Table 1, tee shirts are often made solely from grade 1 PET, plastic crates are often made solely from grade 2 HDPE and plastic bags are often made solely from grade 4 LDPE.

Problematically, one of the reasons for making recycled plastic products solely from a single grade of plastic 120 is because the different grades do not bond easily together, due to their different chemical compositions. Advantageously however, as will be discussed in greater detail herein, the recycled plastic product made from utilizing method 100 of the present invention may be a blend of several different grades, including all grades 1-6. This feature of the present invention may significantly enhance the capability and flexibility of recycling plastics 120 and reduce the amount of waste plastic filling up landfills or oceans.

Referring to FIG. 4, an example is depicted of a perspective view of a grinding machine 146 performing steps 106 and 108 in the method 100 of FIG. 1. In step 106, the single grade batches 140-1-140-6 of recyclable plastic material are ground down by the grinding machine 146 to single grade groups 148-1-148-6 of recyclable plastic chips 148. Thereafter, in step 108, the chips 148 are weighed out to provide single grade portions 150-1-150-6 of equal weight recyclable plastic chips.

At step 106 of method 100, each single grade batch 140-1-140-6 of the bulk recyclable plastic materials 120 are fed into a grinding machine (or a shredding machine) 146. The grinding machine 146 may be, for example, grinding machine model number WLK8 made by WEIMA, having a location in Fort Mill, S.C.

Each single grade batch 140-1-140-6 of recyclable plastic material 120 is then ground into a single grade group 148-1 through 148-6 group of recyclable plastic chips 148. The grinding machine 146 reduces the size of the bulk plastic 120 to 3 inch by 3 inch by 3 inch chips 148 or smaller. The discharge of the grinding machine 146 drops the chips 148 into another set of bins 134, one bin 134 for each single grade group 148-1 through 148-6.

It is advantageous that the chips 148 have overall maximum dimensions that are 3 inches by 3 inches by 3 inches or smaller. By grinding single grade batch 140 of recyclable plastic material 120 into chips 148 having these dimensions or smaller, mixing of various grades of plastic chips 148 is more uniformly achieved later in the process, which enhances the bonding of the various grades in the final recycled plastic product 170 (seen in FIGS. 6 and 7). The chips 148 may be ground down to smaller dimensions as well to further enhance mixing. For example, the chips 148 may be ground down to 2 inches by 2 inches by 2 inches or less. Also, the chips 148 may be ground down to 1 inch by 1 inch by 1 inch or smaller.

At step 108 of method 100, a portion of each single grade group 148-1-148-6, is weighed out into a single grade portion 150-1 through 150-6, wherein each portion 150 is of equal weight to the other portions 150 (regardless of grade 1-6) within a range of plus or minus 15 percent. In the example illustrated in FIG. 4, the bin 134 that the chips 148 are discharged into from the grinding machine 146 is located over an industrial scale 152. The scale 152 weighs each portion 150 of chips as they fill the bin 134 until the portion 150 of chips reach a predetermined equal weight, wherein the grinding process is then stopped and the bin 134 is removed and replaced. In this way, all of the chip portions 150 in each bin 134 are of equal weight. The portions 150 may be of equal weight within a range of plus or minus 15 percent, within a range of plus or minus 10 percent, within a range of plus or minus 5 percent, within a range of plus or minus 2 percent or within a range of plus or minus 1 percent.

In the example illustrated in FIG. 4, the equal weight single grade portions of chips 150-1-150-6, are 100 percent of the total weight of the single grade groups of chips 148-1-148-6 discharged from the grinding machine 146. Alternatively, the portions 150 of equal weight chips may weigh less than the total weight of the single grade groups 148 of chips. For example, the full form plastic 120 in a single grade batch 140, may be ground down to a large single grade group 148 of chips and discharged into a large bin 134 all at once. From the large bin 134, only a fraction (for example half or less) of the single grade group 148 of chips may then be scooped out into smaller bins to form the equal weight single grade portions 150 of chips. This process would be done for each grade 1-6 of each portion 150, wherein all the portions 150 would be of equal weight regardless of the grade 1-6 in each portion.

Separating each grade of chips into equal weight single grade portions 150-1 through 150-6 is advantageous, because it enables more effective future blending and binding of different grades 1-6 of recyclable plastic material 120 into one recycled plastic product 170 (seen in FIGS. 6 and 7). More specifically, if a plurality of grades 1-6 of recyclable plastic 120 is mixed together throughout the entire recycled plastic product 170, wherein each grade of recyclable plastic is of equal amount by weight within a range of plus or minus 15 percent, the different grades may bind together without a significant amount of weak spots or fractures being formed. Additionally, if fractures do form, they are usually small in number and length relative to the overall dimensions of the product 170.

This is especially the case if the product 170 has an overall volume large enough to encompass a spherical volume of at least 1.0 inch in diameter. For example, two grades of plastic (for example grades 1 and 2) may bind together in a product 170, if each grade makes up half the weight of the product and the overall dimensions of the product is large enough in every direction such that it will encompass a 1.0 inch diameter sphere or greater. In another example, six grades may bind together in a product 170, if each grade makes up one sixth the weight of the product and the overall dimensions of the product is large enough in every direction such that it will encompass a 1.0-inch diameter sphere.

It is important that the weight of each grade in the recycled plastic product 170 be equal within a range of plus or minus 15 percent or the various grades 1-6 will not be distributed evenly throughout the entire product 170, weak bonds between the grades of plastic may form and a significant amount of undesirable cracks may also develop. For example, if the weight of one grade is 50 percent larger than the weight of the other grades, the product will be weaker than if all the grades were of equal weight and may form a significant amount of cracks throughout the product.

Additionally, if any one overall dimension of the recycled product 170 is less than 1.0 inch (for example, if the recycled product were 0.5-inch-thick floor board), then cracks that may develop along the short dimension may significantly weaken the product. Conversely, if the product 170 had all three dimensions (i.e., height, width and length) equal to or greater than 1.0 inch and the product were a composite of equal weight grades of plastic mixed throughout the entirety of the product, then the risk of fractures is greatly reduced and any cracks that might develop may be short relative to the thinnest dimension of the product.

The minimum dimensions of the recycled product 170 in accordance with the present invention may be larger than 1.0 inches as well. For example, the product may have an overall volume large enough to encompass a spherical volume of at least 1.5 inches in diameter, at least 2.0 inches in diameter, at least 2.5 inches in diameter or at least 3.0 inches in diameter. Additionally, the product may have an overall volume large enough to encompass a cubic volume of at least one foot in width, one foot in height and one foot in length. Additionally, the product may have a smallest dimension in one of height, length and width that is at least 1.0 inches, at least 1.5 inches, at least 2.0 inches, at least 2.5 inches or at least 3.0 inches.

An example of such a product 170, would be a recycled plastic block 170A (seen in FIG. 6) that is operable to form a retaining wall 171 in a construction site. The block may have dimensions of 2.5 feet by 2.5 feet by 4 feet and have a plurality of equal grades of recyclable plastic mixed together throughout the entire product.

Another example of such a product 170 would be a plurality of pellets 170A (seen in FIG. 7) that is operable to be used as construction aggregate for a drainage system 173 in a construction site. Each pellet may be spherical, or tear drop shaped and may have an overall dimension that is larger than a sphere of 1.0 inches in diameter. Each pellet may also have a plurality of equal grades of recyclable plastic mixed together throughout the entire product.

Referring to FIG. 5, an example is depicted of a perspective view of a mixing machine 160 performing steps 110 and 112 in the method 100 of FIG. 1. In step 110, the single grade portions 150 of equal weight are mixed together to form a multiple grade mixture 158 of recyclable plastic chips. In step 112, sand 156 is mixed into the multiple grade mixture 158.

At step 110 of method 100, each single grade portion 150-1 to 150-6 is mixed together to form a multiple grade mixture 158 of recyclable plastic chips. The multiple grade mixture 158 may be composed of any combination of single grade portions 150-1-150-6. That is, the multiple grade mixture 158 may include only grades 1 and 2, all grades 1-6 and any other combination of grades 1-6. What is advantageous, is that the grade portions 150 in the multiple grade mixture 158 are of equal weight.

In FIG. 5, the single grade equal weight portions 150 are loaded into a drum 162 of the mixing machine 160, much like loading cement into a dump truck. The mixing machine rotates the drum for a first predetermined mixing period to thoroughly and evenly mix the various single grade portions 150 of chips throughout the multiple grade mixture 158. The first predetermined mixing period may be at least 3 minutes, at least 5 minutes, at least 8 minutes, at least 10 minutes or higher.

At step 112 of method 100, after thoroughly mixing the single grade portions 150 into the multiple grade mixture 158, sand 156 may be mixed into the multiple grade mixture of recyclable plastic chips. The sand 156 may have a weight within a range of 1 to 4 percent of a weight of the multiple grade mixture. The sand 156 may also have a grain size within a range of 0.25 to 2 millimeters.

The mixing machine rotates the drum for a second predetermined mixing period to thoroughly coat the plastic chips in the multiple grade mixture 158 with the sand 156. It is important to thoroughly mix the sand with the chips, because the sand acts as a binder that enhances the binding of the different grades of plastics and reduces the possibility of fractures forming within the recycled plastic product 170. Accordingly, the second predetermined mixing period may be at least 2 minutes, at least 3 minutes, at least 4 minutes, at least 5 minutes or higher to thoroughly mix the sand and chips together.

The size of the sand 156 is important. This is because, it is the grain size of the sand that provides enough surface area for the various different grades of plastic to bind to, in order to enhance the strength of the final product 170. If the sand's grain size is too small, there will not be enough surface area for the plastic grades to bind to securely. On the other hand, if the grain size is too big, the sand 156 itself will act as an oversized contaminate that will tend to fracture the final product 170.

For purposes herein, grain size of the sand refers to the average diameter of the individual gains of sand. The well-known Udden-Wentworth grain-size scale (or Wentworth scale) is widely used as the standard for objective description of sand and other sediment sizes. Per the Wentworth scale, any sediment that has a grain size of from 0.06 to 2 millimeters in diameter is classified as sand. The Wentworth scale also further classifies the sand sizes as follows:

| Sand Classification | Grain size in millimeters (mm) |
|---|---|
| Very coarse sand | 1-2 mm |
| Coarse sand | 0.5-1.0 mm |
| Medium sand | 0.25-0.5 mm |
| Fine sand | 0.125-0.25 mm |
| Very fine sand | 0.0625-0.125 mm |

In order to provide the proper surface area to bind to the different grades of plastic without being so big that the grain size may cause unwanted weaknesses in the recycled plastic product 170, the grain size of the sand may be within a range of 0.25 to 2 millimeters. Grain size within this range may be considered to include medium sand, coarse sand and very coarse sand on the Wentworth scale. Additionally, the grain size of the sand may be within the range of 0.5-2 mm, which is considered to include coarse sand and very coarse sand on the Wentworth scale. Additionally, the grain size of the sand may be within the range of 0.5-1 mm, which is considered to include solely coarse sand on the Wentworth scale.

In addition to the grain size, the proportional amount of the sand 156 relative to the total weight of the multiple grade mixture 158 is also important. Again, too much sand 156 could tend to produce fractures and too little sand may not provide enough surface area for the various grades 1-6 of recyclable plastic 120 to bind to. In order to meet the proper proportionality of sand to plastic, the sand may have a weight within a range of 1 to 4 percent of a weight of the multiple grade mixture. For example, for 1000 pounds of multiple grade mixture 158, weight of sand 156 within a range of 10 pounds to 40 pounds may be mixed in with it. Alternatively, for 1000 pounds of multiple grade mixture 158, a weight of sand 156 within a range of 2 to 3 percent (or 20 to 30 pounds) may be mixed in with mixture 158.

Referring to FIG. 6, an example is depicted of a perspective view of an extruder 166 performing steps 114 and 116 in the method 100 of FIG. 1. In step 114, the multiple grade mixture 158 of recyclable plastic chips 156 and sand are heated, by for example the extruder 166, to form a multiple grade blend 164 of molten recyclable plastic. Thereafter, at step 116, the multiple grade blend 164 is cooled into the form of a recycled plastic product 170. The recycled plastic product in the specific example illustrated in FIG. 6 is a recycled plastic block 170A operable to form a retaining wall 171 (see FIG. 6). As will be discussed in greater detail herein, an alternative recycled plastic product 170 is illustrated in FIG. 7 as a pellet 170B operable to be used as construction aggregate in a drainage system 173.

It is important to note, that up to this point in the exemplary method 100 of the present invention, the contaminates 133 have not been removed from the plastic materials 120. Prior art methods would have employed one or more washing processes to remove at least some or a majority of the contaminates 133. Advantageously, in the method 100 of the present invention, a washing process to remove the contaminates 133 may not be required.

It is also important to note, that after mixing sand 156 with the multiple grade mixture 158 at step 112, the weight of the contaminates 133 in the multiple grade mixture 158 may be significantly less than the weight of the sand 156 added to the mixture 158. For example, the contaminates 133 may be within a range of 10 percent to 90 percent of the weight of the sand, 20 percent to 80 percent of the weight of the sand or 30 percent to 70 percent of the weight of the sand. Essentially, the sand 156 may become the dominate contaminate in the mixture 158 and is introduced into the mixture 158 in controlled amounts and sizes in order to enhance the binding of the different grades of plastics, with or without contaminates 133.

At step 114 of the method 100, the multiple grade mixture 158 of recyclable plastic chips 156 and sand are fed into the extruder 166 and heated to form a multiple grade blend 164 of molten recyclable plastic. The extruder may be, for example, an EREMA extruder made by EREMA, having a location in Fort Mill, S.C.

The extruder typically has an electrically heated auger 167 that heats the multiple grade mixture of recyclable plastic chips 158, along with the sand 156, up to the melting temperature range of the plastic. The melting temperature range of grades 1-6 plastic is generally 420 degrees Fahrenheit (F) within a very small range of typically plus or minus 5 degrees F. At those temperatures, the plastic grades will melt, any organic portion of the contaminates 133 will carbonize, and the sand 156 will remain as is.

The auger 167 is designed to reach the melting range of the plastics about mid-way through its length. For example, if the auger 167 is 12 feet long, it will often reach the melting point of the plastics at about 6 feet into the auger. The last 6 feet will be used to further mix the molten multiple grade blend 164 of plastics, the sand 156 and contaminates 133 (if any).

It is important to note that at this point of the method 100 in accordance with the present invention, no filtering screens are used to remove the contaminates 133. Prior art methods would often require filter screens that would have to be changed frequently to remove the contaminates 133. Advantageously, the exemplary method 100 may not require filter screens, therefore saving time and money.

Though an extruder with an electrically heated auger 167 is illustrated in FIG. 6 as heating the mixture 158, other devices and systems may be used to perform the heating process. For example, the mixture 158 may be heated in a vats in a heating oven.

At step 116, the multiple grade blend is cooled into a form of a solid recycled plastic product 170. The recycled plastic product 170 includes a plurality of grades of recyclable plastic mixed together throughout the entire product 170. Each grade of recyclable plastic is of equal amount by weight within a range of plus or minus 15 percent. The product 170 has an overall volume large enough to encompass a spherical volume of at least 1.0 inches in diameter.

Additionally, the recycled plastic product 170 may also include sand 156 mixed throughout the entire product. The sand may have a weight within a range of 1 to 4 percent of a combined weight of the plurality of grades of recyclable plastic within the product 170. The sand may also have a grain size within a range of 0.25 to 2 millimeters.

Additionally, the recycled plastic product 170 may also include contaminates 133 that have adhered to the recyclable plastic materials 120 during the collection step 102. The weight of the contaminates 133 in the recycled plastic product 170 would be significantly less than the weight of the sand 156. For example, the weight of the contaminates 133 may be within a range of 10 percent to 90 percent (%) of the weight of the sand 156, 20% to 80% of the weight of the sand 156 or 30% to 70% of the weight of the sand 156. Moreover, any contaminates that have been carbonized during the heating process within the auger 167, may bind to the sand 156 as well.

In the particular recycled plastic product 170 illustrated in FIG. 6, the product 170 includes a recycled plastic block 170A operable to form a retaining wall 171. The block 170A is formed by pouring the molten multiple grade blend 164 it into a mold 168, which cools to form the block. The block 170A includes an overall volume large enough to encompass a cubic volume of at least one foot in width, one foot in height and one foot in length.

The recycled plastic block 170A may be operable to withstand a total compression force of at least 20,000 pounds without cracking. Therefore, for example, a block 170A that has dimensions of 2.5 feet by 2.5 feet by 4 feet and weighs 1000 pounds, may be safely stacked in a retaining wall 171 up to 20 blocks tall.

However, with sand 156 mixed into the block 170A may be operable to withstand a total compression force of at least 25,000 pounds, or at least 30,000 pounds without cracking. Therefore, for example, a block 170A that has dimensions of 2.5 feet by 2.5 feet by 4 feet and weighs 1000 pounds, may be safely stacked in a retaining wall 171 up to 30 blocks tall if the proper amount of sand 156 is incorporated into the block 170A.

Referring to FIG. 7, an example is depicted of a perspective view of the extruder 166 again performing steps 114 and 116 in the method 100 of FIG. 1, wherein the recycled plastic product 170 is a plurality of pellets 170B operable to be used as construction aggregate in a drainage system 173 for a construction site. Each pellet 170B of the plurality of pellets include a plurality of grades (such as grades 1-6) of recyclable plastic mixed together throughout the entirety of each pellet. Each grade of recyclable plastic is of equal amount by weight within a range of plus or minus 15 percent. Additionally, each pellet may have an overall volume large enough to encompass a spherical volume of at least 1.0 inches in diameter. Alternatively, each pellet may also have an overall volume large enough to encompass a spherical volume of at least 2.0 inches in diameter.

Moreover, the pellets 170B may also include sand 156 mixed throughout the entirety of each pellet. The 156 sand may have a weight within a range of 1 to 4 percent of a combined weight of the plurality of grades (for example grades 1-6) of recyclable plastic within each pellet. The sand also may have a grain size within a range of 0.25 to 2.0 millimeters.

The pellets 170A may be formed by extruding the multiple grade blend 164 through a grating 172 having a plurality of through-hole structures 174. The multiple grade blend 164 drips off of the grating 172 as it extrudes through the through-hole structures 174 to form a plurality of molten droplets 176. The plurality of molten droplets 176 then cool into a plurality of solid recycled plastic pellets 170B.

Though the recycled plastic product 170 has been illustrated herein as a block 170A operable to be used in a retaining wall 171 (see FIG. 6) and a plurality of pellets 170B operable to be used in a drainage system 173 (see FIG. 7) it is within the scope of the present invention that the recycled plastic product 170 may take several other forms. For example, the recycled plastic product 170 may be in the form of a barricade or a Jersey barrier operable to be used for road construction and/or temporary traffic control. Also, by way of example, the recycled plastic product 170 may be in the form of a car stop operable to be used to provide a barrier for wheels of a vehicle to abut against when parking the vehicle in a parking lot.

It should be appreciated that all combinations of the foregoing concepts and additional concepts discussed in greater detail herein (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

Although the invention has been described by reference to specific examples, it should be understood that numerous changes may be made within the spirit and scope of the inventive concepts described. Accordingly, it is intended that the disclosure not be limited to the described examples, but that it have the full scope defined by the language of the following claims.

What is claimed is:

1. A method of making a recycled plastic product, the method comprising:
collecting recyclable plastic materials;
separating the recyclable plastic materials into a plurality of single grade batches of recyclable plastic materials;
grinding each single grade batch of recyclable plastic materials into a single grade group of recyclable plastic chips;
weighing out a single grade portion from each single grade group of recyclable plastic chips, wherein each single grade portion is equal in weight within a range of plus or minus 15 percent;
mixing together each single grade portion to form a multiple grade mixture of recyclable plastic chips;
heating the multiple grade mixture to form a multiple grade blend of molten recyclable plastic; and
cooling the multiple grade blend into a form of a solid recycled plastic product, the recycled plastic product comprising multiple grades of recyclable plastic and have a volume large enough to encompass a spherical volume of at least 1.0 inches in diameter.

2. The method of claim 1, comprising:
mixing sand into the multiple grade mixture of recyclable plastic chips, the sand having a weight within a range of 1 to 4 percent of a weight of the multiple grade mixture, the sand also having a grain size within a range of 0.25 to 2 millimeters;
heating the sand and the multiple grade mixture of recyclable plastic chips to form the multiple grade blend of molten recyclable plastic; and
cooling the multiple grade blend into a form of a solid recycled plastic product.

3. The method of claim 1, wherein each single grade portion is equal in weight within a range of plus or minus 15 percent.

4. The method of claim 1, wherein the separating comprises:
separating the recyclable plastic materials into six single grade batches of recyclable plastic materials, each batch comprised of a different grade of recyclable plastic grade types 1 through 6.

5. The method of claim 2, comprising:
collecting recyclable plastic material shaving contaminates adhered to the surface of the recyclable plastic materials;
wherein the multiple grade mixture of recyclable plastic chips includes a portion of the contaminates, the portion of the contaminates having a weight that is within a range of 10 percent to 90 percent of the weight of the sand.

6. The method of claim 5, comprising:
heating the contaminates, the sand and the multiple grade mixture of recyclable plastic chips to form the multiple grade blend of molten recyclable plastic; and
cooling the multiple grade blend into a form of a solid recycled plastic product, the recycled plastic product comprising a composite of multiple grades of recyclable plastic, sand and contaminates.

7. The method of claim 6, wherein the recycled plastic product includes any two of recyclable plastic grade types 1 through 6.

8. The method of claim 6, wherein the recycled plastic product includes all of recyclable plastic grade types 1 through 6.

9. The method of claim 2, wherein the cooling further comprises:
pouring the multiple grade blend into a mold; and
cooling the multiple grade blend in the mold to form a solid block, the block comprising:
at plurality of grades of recyclable plastic mixed together throughout the entire block, each grade of recyclable plastic being of equal amount by weight within a range of plus or minus 15 percent,
sand mixed throughout the entire block, the sand having a weight within a range of 1 to 4 percent of a combined weight of the plurality of grades of recyclable plastic within the block, the sand also having a grain size within a range of 0.25 to 2 millimeters,
wherein, the block has an overall volume large enough to encompass a cubic volume of at least one foot in depth, one foot in height and one foot in width.

10. The method of claim 9, wherein the block is operable to withstand a total compression force of at least 20,000 pounds without cracking.

11. The method of claim 2, wherein the cooling further comprises:
extruding the multiple grade blend through a grating having a plurality of through-hole structures; and
dripping the multiple grade blend off of the grating as it extrudes through the through-hole structures to form a plurality of molten droplets;
cooling the plurality of molten droplets into a plurality of solid recycled plastic pellets, the plurality of recycled plastic pellets comprising:
at plurality of grades of recyclable plastic mixed together throughout the entirety of each pellet, each grade of recyclable plastic being of equal amount by weight within a range of plus or minus 15 percent;
sand mixed throughout the entirety of each pellet, the sand having a weight within a range of 1 to 4 percent of a combined weight of the plurality of grades of recyclable plastic within each pellet, the sand also having a grain size within a range of 0.25 to 2 millimeters;
wherein, each pellet has an overall volume large enough to encompass a spherical volume of at least one inch in diameter.

12. The plurality of recycled plastic pellets of claim 11, wherein each pellet includes all recyclable plastic grade types 1 through 6.

13. A recycled plastic product, comprising:
a plurality of grades of recyclable plastic mixed together throughout the entire product, each grade of recyclable plastic being of equal amount by weight within a range of plus or minus 15 percent;
wherein, the product has an overall volume large enough to encompass a spherical volume of at least 1.0 inches in diameter.

14. The recycled plastic product of claim 13, comprising
sand mixed throughout the entire product, the sand having a weight within a range of 1 to 4 percent of a combined weight of the plurality of grades of recyclable plastic within the product, the sand also having a grain size within a range of 0.25 to 2 millimeters.

15. The recycled plastic product of claim 14, wherein the product includes all recyclable plastic grade types 1 through 6, each grade being of equal amount by weight within a range of plus or minus 15 percent.

16. The recycled plastic product of claim 14, wherein the product comprises a recycled plastic block operable to form a retaining wall, the block comprising an overall volume large enough to encompass a cubic volume of at least one foot in width, one foot in height and one foot in length.

17. The recycled plastic product of claim 16, wherein the block is operable to withstand a total compression force of at least 20,000 pounds without cracking.

18. The recycled plastic product of claim 14, wherein the product comprises a plurality of recycled plastic pellets operable to be used as construction aggregate for a drainage system in a construction site, each pellet of the plurality of pellets comprising:
a plurality of grades of recyclable plastic mixed together throughout the entirety of each pellet, each grade of recyclable plastic being of equal amount by weight within a range of plus or minus 15 percent;
wherein, each pellet has an overall volume large enough to encompass a spherical volume of at least 1.0 inches in diameter.

19. The recycled plastic product of claim 18, wherein each pellet of the plurality of pellets comprises:
sand mixed throughout the entirety of each pellet, the sand having a weight within a range of 1 to 4 percent of a combined weight of the plurality of grades of recyclable plastic within each pellet, the sand also having a grain size within a range of 0.25 to 2.0 millimeters.

20. The recycled plastic product of claim 19, wherein each pellet of the plurality of pellets comprises an overall volume large enough to encompass a spherical volume of at least 2.0 inches in diameter.
